(19) United States
(12) Patent Application Publication
(10) Pub. No.: US 2016/0346656 A1
(43) Pub. Date: Dec. 1, 2016

(54) GRIP TAPE WITH HOT-MELT ADHESIVE

(71) Applicant: HIGH CEDAR ENTERPRISE CO., LTD., TAICHUNG CITY (TW)

(72) Inventor: Yung-Han WANG, TAICHUNG CITY (TW)

(21) Appl. No.: 15/237,086

(22) Filed: Aug. 15, 2016

Related U.S. Application Data
(63) Continuation-in-part of application No. 14/722,611, filed on May 27, 2015.

(30) Foreign Application Priority Data
Dec. 31, 2014 (TW) 103223395

(51) Int. Cl. A63B 60/14; B32B 7/12; B32B 1/08

(52) U.S. Cl. CPC A63B 60/14; B32B 1/08; B32B 7/12; B32B 2307/56

(57) ABSTRACT

A grip tape includes a tubular body and a bonding portion. The tubular body is configured to be mounted around the grip of a club, racket, or bat. The bonding portion is provided on the inner periphery of the tubular body and has first and second adhesive layers. The second adhesive layer lies between the inner periphery of the tubular body and the first adhesive layer and is adhesively bonded to the inner periphery of the tubular body. The first adhesive layer is hot-melt adhesive to be bonded to the grip through a heating reaction or hot pressing operation of a predetermined temperature. The grip tape, therefore, can be easily bonded to the grip via the heating reaction or hot pressing operation.

This application is a Continuation-In-Part of U.S. patent application Ser. No. 14/722,611 filed on May 27, 2015, titled “Grip With Double-Layer Adhesive Bound Structure” by HIGH GEDAR ENTERPRISE CO., LTD. This application published on Jun. 30, 2016 with the published number 20160184672A. This application discloses and claims a grip tape with double layer adhesive bound structure and one of the double layer adhesive is hot-melt adhesive.

### BACKGROUND OF THE INVENTION

1. Technical Field

The present invention relates to a grip tape and more particularly to one with hot-melt adhesive.

2. Description of Related Art

FIG. 1 shows the handle, or grip, 10 of a conventional baseball bat. The grip 10 is composed of a gripping portion 11 and a grip tape 13 wrapped around the gripping portion 11. The grip tape 13 is wound spirally around the gripping portion 11 from one end of the gripping portion 11 to the other end along the longitudinal direction of the gripping portion 11. An overlapped seam 131 is formed where the helically wound grip tape 13 overlaps itself.

FIG. 2 shows the grip 20 of another conventional baseball bat. The grip 20 is composed of a gripping portion (no reference numeral given in the drawing) and a grip tape 23 wrapped around the gripping portion. The grip tape 23 is in the shape of a sheet and surrounds the gripping portion in such a way that a connecting seam 231 is formed along the longitudinal direction of the gripping portion.

To complete the grips 10, 20, the grip tapes 13, 23 must be prepared in advance, for example by applying adhesive or glue to the side of the grip tapes 13, 23 that is to be attached to the gripping portion and then covering the resulting adhesive surface with release paper or protective paper. When it is ready to adhesively attach the adhesive or glue on the grip tapes 13, 23 to the gripping portion, the release paper or protective paper is peeled off to expose the adhesive or glue on the adhesive surface of the grip tapes 13, 23 so that subsequent bonding operation can be carried out.

However, the foregoing process of finishing the grips 10, 20 still leaves room for improvement. More specifically, if the adhesive or glue on the grip tape 13 or 23 is to be adhesively attached to the gripping portion after the grip tape 13 or 23 is wound around the gripping portion, an additional jig or process will be required to remove the release paper or protective paper from the adhesive or glue on the adhesive surface of the grip tape 13 or 23, which is very inconvenient. This is especially true when the grip tape has a tubular structure, for it is by no means easy to peel the release paper or protective paper off a tubular grip tape put around the gripping portion of a bat. The present invention is intended to provide an effective solution to the aforesaid drawback of the prior art.

### BRIEF SUMMARY OF THE INVENTION

In light of the above, it is an objective of the present invention to provide a grip tape with double-layer adhesive bound structure and one of the adhesive is hot-melt adhesive so that the grip tape can be bonded to the grip of a club, racket, or bat through a heating reaction or hot pressing process of a predetermined temperature, thereby facilitating the operation to be performed to finish the grip.

To achieve the objective, the grip tape of the present invention includes a tubular body and at least one bonding portion. The tubular body is configured to be mounted around the grip of a club, racket, or bat. The at least one bonding portion is provided on the inner periphery of the tubular body and has a first adhesive layer and a second adhesive layer. The second adhesive layer lies between the inner periphery of the tubular body and the first adhesive layer. The first adhesive layer is hot-melt adhesive to be bonded to the grip through a heating reaction or hot pressing operation of a predetermined temperature.

Preferably, there are a plurality of bonding portions, and the bonding portions are adhesively bonded between the tubular body and the grip and each extend from one end of the tubular body to the other end along the longitudinal direction of the tubular body.

Preferably, there are a plurality of bonding portions, and the bonding portions are adhesively bonded between the tubular body and the grip, extend in the circumferential direction of the tubular body, and are arranged along the longitudinal direction of the tubular body.

### BRIEF DESCRIPTION OF THE SEVERAL VIEWS OF THE DRAWINGS

FIG. 1 schematically shows a conventional grip tape applied to the gripping portion of a bat;

FIG. 2 schematically shows another conventional grip tape applied to the gripping portion of a bat;

FIG. 3 schematically shows the first preferred embodiment of the present invention applied to the gripping portion of a bat;

FIG. 4 is an enlarged sectional view of the circled area A in FIG. 3;

FIG. 5 is a sectional view taken along the line 5-5 in FIG. 3;

FIG. 6 is a sectional view showing the second preferred embodiment of the present invention applied to the gripping portion of a club, racket, or bat; and

FIG. 7 is a sectional view showing the third preferred embodiment of the present invention applied to the gripping portion of a club, racket, or bat.

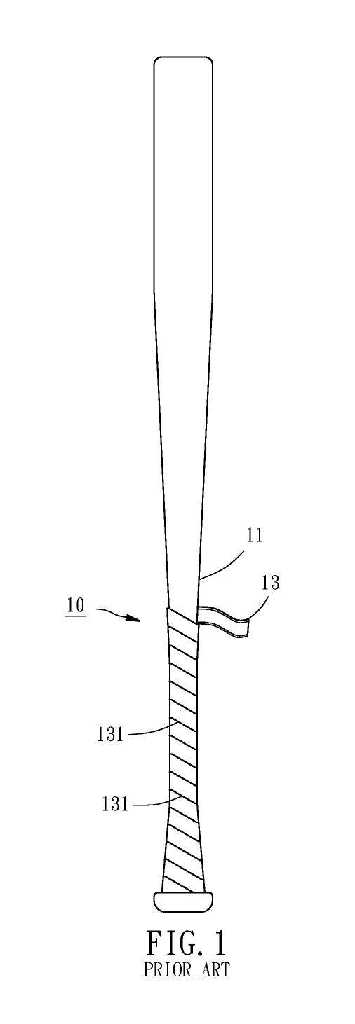

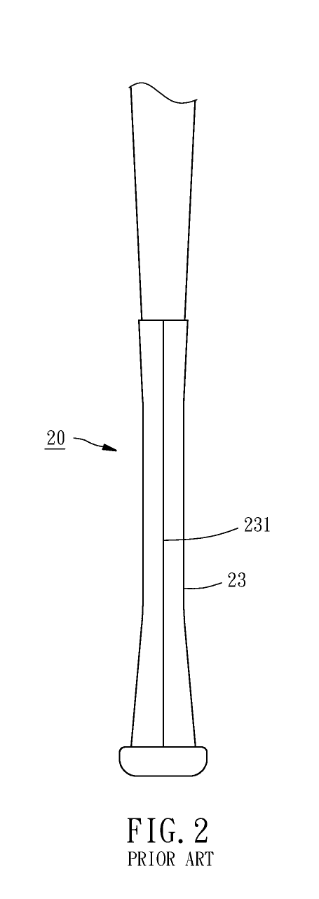

### DETAILED DESCRIPTION OF THE INVENTION

The structural features of the present invention and their intended effects are detailed below with reference to some illustrative embodiments in conjunction with the accompanying drawings. Please note that the same reference numerals used in the embodiments and the drawings refer to the same or similar elements, components, articles, structures, systems, architectures, devices, process flows, methods, or steps.

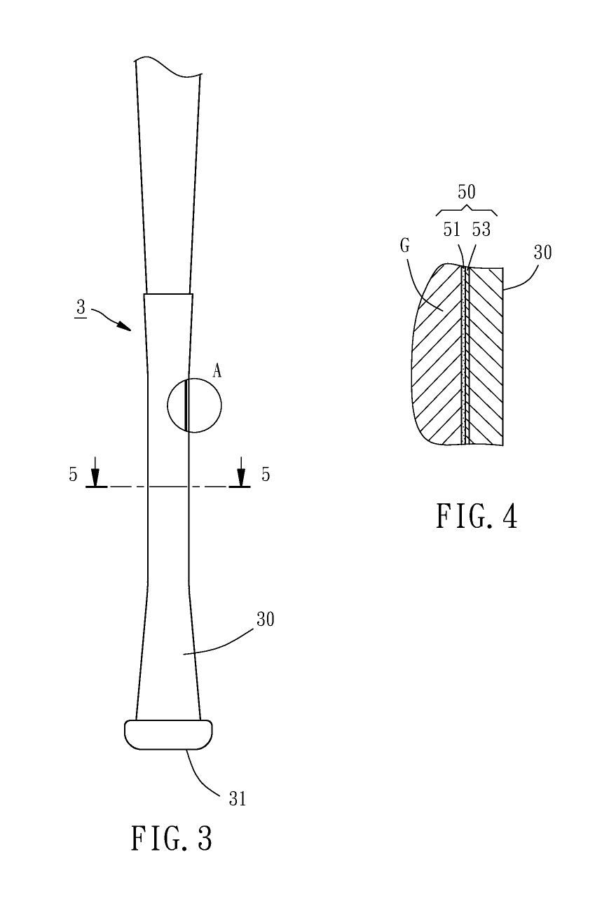

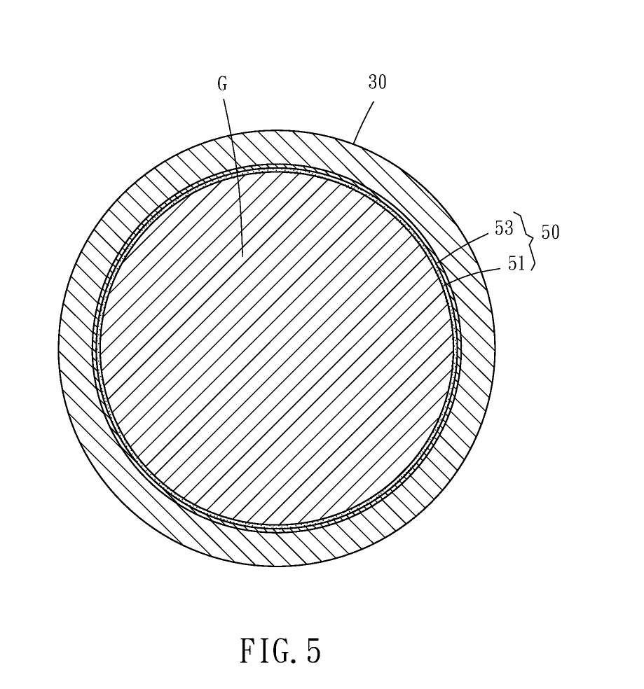

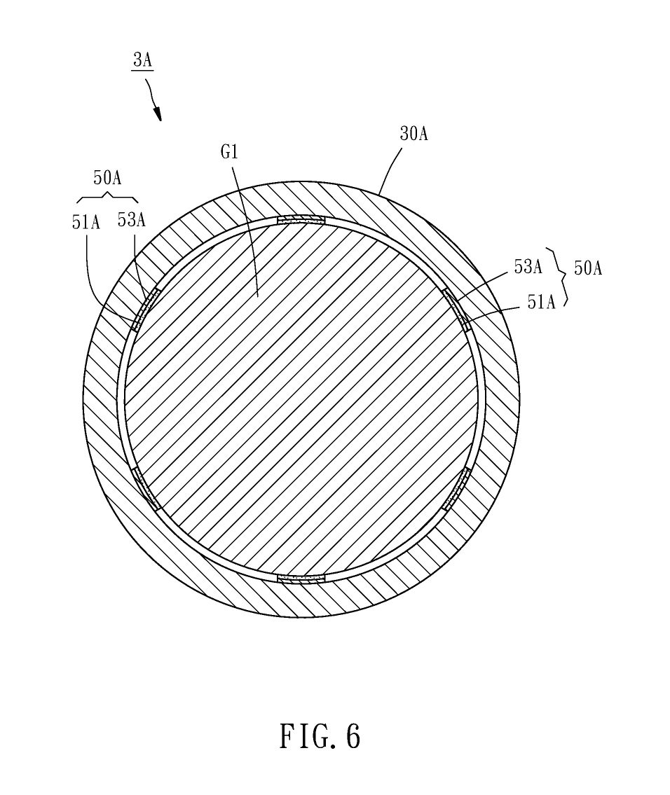

Referring to FIG. 3 to FIG. 5, the grip tape 3 according to an embodiment of the present invention includes a tubular body 30 and a bonding portion 50.

The tubular body 30 is configured to be mounted around the grip G of a club, racket, or bat, such as the grip of a hockey stick, tennis racket, or baseball bat. The inner periphery of the tubular body 30 is substantially composed of a felted material or component for example.

The bonding portion 50 is provided on and covers the inner periphery of the tubular body 30.

The bonding portion 50 has a first adhesive layer 51 and a second adhesive layer 53. The sides of the two adhesive layers 51, 53 that face each other are adhered, bonded, or adhesively attached to each other. The second adhesive layer 53 lies between the inner periphery of the tubular body 30 and the first adhesive layer 51 and is adhesively bonded to the felted component constituting the inner periphery of the tubular body 30. The first adhesive layer 51 is hot-melt adhesive and can be bonded to the grip G of the club, racket, or bat by a heating reaction or hot pressing operation of a predetermined temperature.

In this embodiment, the hot-melt adhesive of the first adhesive layer 51 of the bonding portion 50 is composed of, for example, ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive. The first adhesive layer 51 can be bonded to the grip G through a heating reaction or hot pressing operation of a predetermined temperature ranging generally from 60° C. to 300° C. The second adhesive layer 53 of the bonding portion 50 is composed of, for example, a solvent-based adhesive tape, an emulsion-based adhesive tape, a hot-melt adhesive tape, a rolled adhesive tape, or a reactive adhesive tape. The second adhesive layer 53 is adhesively bonded to the inner periphery of the tubular body 30.

The technical features of this embodiment have the following advantageous effects over the prior art:

As the first adhesive layer 51 of the bonding portion 50 of the grip tape 3 is hot-melt adhesive, which is not adhesive until subjected to the heating reaction or hot pressing operation, one can easily mount the tubular body 30 of the grip tape 3 around the grip G of the club, racket, or bat. After that, the heating reaction or hot pressing operation (of a predetermined temperature ranging generally from 60° C. to 300° C.) is performed to bond the first adhesive layer 51 of the bonding portion 50 of the grip tape 3 to the grip G of the club, racket, or bat, thereby achieving secure adhesion between the grip tape 3 and the grip G.

The present embodiment is distinctive from the prior art in that the step conventionally required to peel off the release paper or protective paper is eliminated, and that the grip tape can be mounted on the grip of a club, racket, or bat without the assistance of an additional jig or process. Consequently, the process of completing the grip is made easier than in the prior art, and the intended effects and objective of the present invention are attained.

Having detailed the technical features and effects of the first preferred embodiment of the invention, the present specification continues to describe the technical features and effects of the grip tape 3A according to the second preferred embodiment of the invention.

Referring to FIG. 6, the grip tape 3A has substantially the same structure as its counterpart in the previous embodiment except for the following:

There are a plurality of bonding portions 50A, which are adhesively bonded between the tubular body 30A and the grip G1. The bonding portions 50A extend from one end of the tubular body 30A to the opposite end along the longitudinal direction of the tubular body 30A, and each two adjacent bonding portions 50A are spaced by a predetermined spacing. In this embodiment, there are six adjacent yet spaced-apart bonding portions 50A.

Now that the bonding portions 50A of the grip tape 3A in this embodiment are spaced from each other, an overflow of adhesive is effectively prevented when the first adhesive layers 51A of the bonding portions 50A are adhesively bonded to the grip G1, as well as when the second adhesive layers 53A of the bonding portions 50A are adhesively bonded to the tubular body 30A. Besides, the intended effects and objective of the present invention are also achieved.

Having detailed the technical features and effects of the second preferred embodiment of the invention, the present specification continues to describe the technical features and effects of the grip tape 3B according to the third preferred embodiment of the invention.

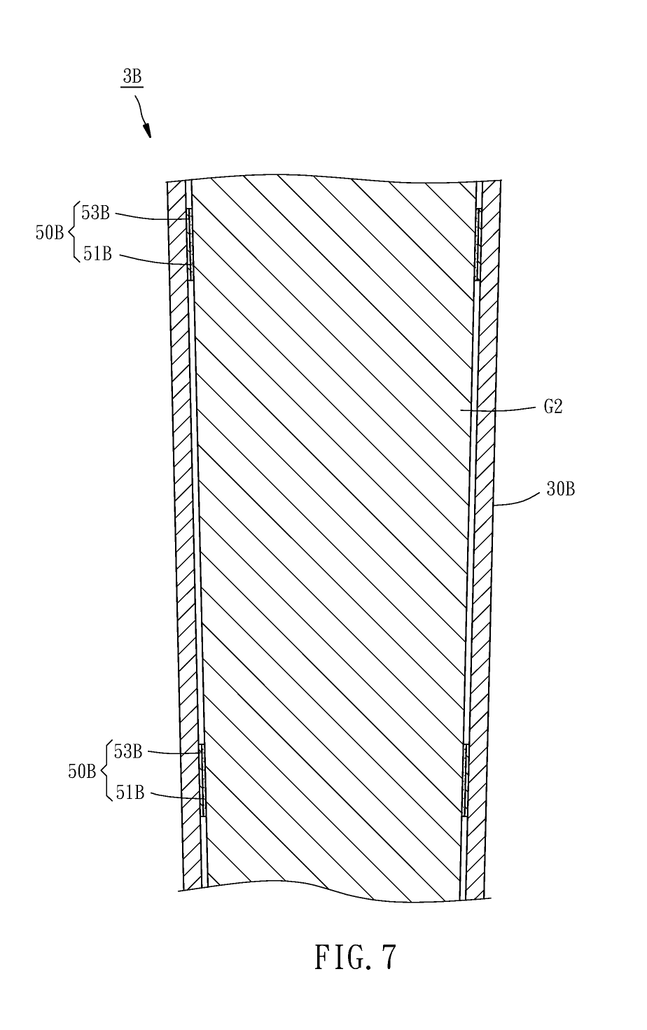

Referring to FIG. 7, the grip tape 3B has substantially the same structure as its counterparts in the first and the second embodiments except for the following:

There are a plurality of bonding portions 50B, which are provided on the inner periphery of the tubular body 30B with a predetermined spacing between each two adjacent bonding portions 50B and are adhesively bonded between the tubular body 30B and the grip G2. Each bonding portion 50B extends in the circumferential direction of the tubular body 30B, and the bonding portions 50B are arranged along the longitudinal direction of the tubular body 30B. In this embodiment, there are six adjacent yet spaced-apart bonding portions 50B.

The bonding portions 50B of the grip tape 3B in this embodiment extend in the circumferential direction of the tubular body 30B and are distributed along the longitudinal direction of the tubular body 30B such that an overflow of adhesive is effectively prevented when the first adhesive layers 51B of the bonding portions 50B are adhesively bonded to the grip G2, as well as when the second adhesive layers 53B of the bonding portions 50B are adhesively bonded to the tubular body 30B. This helps reduce the material cost of the grip tape 3B significantly. Besides, the intended effects and objective of the present invention are also achieved.

What is claimed is:

1. A grip tape, comprising:
a tubular body configured to be mounted around a grip of a club, racket, or bat; and
at least one bonding portion provided on an inner periphery of the tubular body;
wherein the at least one bonding portion has a first adhesive layer and a second adhesive layer, the second adhesive layer lies between the inner periphery of the tubular body and the first adhesive layer, and the first adhesive layer is hot-melt adhesive to be bonded to the grip through a heating reaction or hot pressing operation of a predetermined temperature.

2. The grip tape of claim 1, wherein there are plural said bonding portions, the bonding portions are adhesively bonded between the tubular body and the grip, and each said bonding portion extends from an end of the tubular body to an opposite end of the tubular body along a longitudinal direction of the tubular body.

3. The grip tape of claim 2, wherein each two adjacent said bonding portions are spaced apart.

4. The grip tape of claim 3, wherein each said bonding portion extends along a circumferential direction of the tubular body, and the bonding portions are arranged along the longitudinal direction of the tubular body.

5. The grip tape of claim 1, wherein there are plural said bonding portions, the bonding portions are adhesively bonded between the tubular body and the grip, and each two adjacent said bonding portions are spaced apart.

6. The grip tape of claim 5, wherein each said bonding portion extends along a circumferential direction of the tubular body, and the bonding portions are arranged along a longitudinal direction of the tubular body.

7. The grip tape of claim 1, wherein there are plural said bonding portions, the bonding portions are adhesively bonded between the tubular body and the grip, each said bonding portion extends along a circumferential direction of the tubular body, and the bonding portions are arranged along a longitudinal direction of the tubular body.

8. The grip tape of claim 1, wherein the first adhesive layer of the at least one bonding portion comprises ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive.

9. The grip tape of claim 8, wherein the second adhesive layer of the at least one bonding portion comprises a solvent-based adhesive tape, an emulsion-based adhesive tape, a hot-melt adhesive tape, a rolled adhesive tape, or a reactive adhesive tape.

10. The grip tape of claim 2, wherein the first adhesive layer of the at least one bonding portion comprises ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive.

11. The grip tape of claim 10, wherein the second adhesive layer of the at least one bonding portion comprises a solvent-based adhesive tape, an emulsion-based adhesive tape, a hot-melt adhesive tape, a rolled adhesive tape, or a reactive adhesive tape.

12. The grip tape of claim 3, wherein the first adhesive layer of the at least one bonding portion comprises ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive.

13. The grip tape of claim 12, wherein the second adhesive layer of the at least one bonding portion comprises a solvent-based adhesive tape, an emulsion-based adhesive tape, a hot-melt adhesive tape, a rolled adhesive tape, or a reactive adhesive tape.

14. The grip tape of claim 4, wherein the first adhesive layer of the at least one bonding portion comprises ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive.

15. The grip tape of claim 14, wherein the second adhesive layer of the at least one bonding portion comprises a solvent-based adhesive tape, an emulsion-based adhesive tape, a hot-melt adhesive tape, a rolled adhesive tape, or a reactive adhesive tape.

16. The grip tape of claim 5, wherein the first adhesive layer of the at least one bonding portion comprises ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive.

17. The grip tape of claim 16, wherein the second adhesive layer of the at least one bonding portion comprises a solvent-based adhesive tape, an emulsion-based adhesive tape, a hot-melt adhesive tape, a rolled adhesive tape, or a reactive adhesive tape.

18. The grip tape of claim 6, wherein the first adhesive layer of the at least one bonding portion comprises ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive.

19. The grip tape of claim 18, wherein the second adhesive layer of the at least one bonding portion comprises a solvent-based adhesive tape, an emulsion-based adhesive tape, a hot-melt adhesive tape, a rolled adhesive tape, or a reactive adhesive tape.

20. The grip tape of claim 7, wherein the first adhesive layer of the at least one bonding portion comprises ethylene-vinyl acetate copolymer (EVA)-based hot-melt adhesive, polyamide-based hot-melt adhesive, thermoplastic rubber (TPR)-based hot-melt pressure-sensitive adhesive, polyolefin-based hot-melt adhesive, or moisture-cured polyurethane (PUR)-based hot-melt adhesive.
